(19) United States
(12) Patent Application Publication
(10) Pub. No.: US 2024/0303606 A1
(43) Pub. Date: Sep. 12, 2024

(54) SYSTEMS AND METHODS TO PROPOSE AND MANAGE A PROJECT

(71) Applicant: Owner Builder Homes, Inc., Bluffdale, UT (US)

(72) Inventors: Orrin C. Naylor, Centennial Park, AZ (US); William C. Naylor, Bluffdale, UT (US); H. Adam Naylor, Centennial Park, AZ (US)

(21) Appl. No.: 18/597,747

(22) Filed: Mar. 6, 2024

Related U.S. Application Data
(60) Provisional application No. 63/450,591, filed on Mar. 7, 2023.

(51) Int. Cl. G06Q 10/10

(52) U.S. Cl. CPC G06Q 10/103

(57) ABSTRACT

Systems and methods are disclosed herein for generating a project management plan whereby a construction plan for a project (such as, e.g., a residential home, a commercial building, an outbuilding, a garage, a pool, etc.) is selected from a plurality of construction plans, a building lot is acquired and/or verified for suitability to the construction plan, bids are acquired for each construction trades job involved in construction of the project, individual bids are selected for implementation, a master schedule for construction is generated considering order or build requirements and dependencies, the schedule is implemented, notifications (to commence work, review work, inspect work, etc.) are generated and delivered, permits are acquired, financing is facilitated, payouts are managed (draws generated and delivered), etc., such that the systems and methods herein described constitute a single point for management of each aspect of a project to completion.

### RELATED APPLICATIONS

This application claims priority under 35 U.S.C. § 119(e) to U.S. Provisional Patent Application No. 63/450,591, titled “SYSTEMS AND METHODS TO PROPOSE AND MANAGE A PROJECT,” filed Mar. 7, 2023, which is hereby incorporated herein by reference in its entirety to the extent such subject matter is not inconsistent herewith.

### TECHNICAL FIELD

The present disclosure is directed to generating and/or managing a project, such as, a residential new construction project, a construction project, an improvement project, or the like.

### BACKGROUND

A construction project, such as construction of a home, entails many aspects, such as, selection of a building plan, site selection, site preparation, identification of build trades, determination of trade jobs, selection of service providers, provisioning materials, obtaining permits and inspections, various financial functions, and more. While a number of project management systems exist, presently, none are capable of consolidating more than a limited set of project management functions; and none currently exist that comprise the aspects of selecting building plans along with related trades proposals (trades jobs, or subprojects of the project) that include financial and scheduling data for each particular build plan.

A person (client) intending to build a home, for example, generally goes through a process of acquiring land for the build independent of selecting the building plan. Selecting a building plan, currently, may involve first selecting a contractor, who has or determines a building plan and then manages the build (trades jobs and subprojects) with little or no downstream input, guidance or other involvement from the client. Alternatively, a build plan selection may lead to a search for a contractor willing to undertake the particular build. The contractor, in either case, may select subcontractors (for trades and subprojects) without input from, or regard for preferences of the client, such as using the same subcontractors (subs) for each trades job from build to build without regard for differences in build plans, changes to materials, increasing costs, quality deviations, etc. Currently, obtaining financing for purchasing real estate and/or financing construction and conversion to a mortgage, as well as managing payment of contractors/subs are either partially or completely outside of current project management solutions.

Managing a project using currently available technology inherently results in multiple independent management processes, such as one to deal with acquiring property, another to manage the building scheduling, and another to deal with one or more aspects of the related financials.

### SUMMARY

The present disclosure is directed to systems and methods to generate and manage a project, such as a building project. For example, the present disclosure is directed to systems and methods to facilitate selection of a building plan (e.g., a construction plan) conforming to a property, and/or a property conforming to a building plan, the building plan having trades pre-identified and jobs pre-bid (potentially both as to financial and schedule), and managing the any and all portions of a build, potentially from start to finish. The embodiments of the present disclosure herein described can manage all financial aspects, such as, assisting in procuring a loan, managing payouts on subprojects, as well as inspections, connection fees and scheduling, etc.

Additional aspects and advantages will be apparent from the following detailed description of preferred embodiments, which proceeds with reference to the accompanying drawings.

### BRIEF DESCRIPTION OF THE DRAWINGS

FIG. 1 is a diagram of a project generation and management system (“PGMS”) for generating and managing a master plan for a project, according to an embodiment of the present disclosure.

FIG. 2 is a diagram of a PGMS, according to an embodiment of the present disclosure, and showing trades proposal management.

FIG. 3 is a flow diagram for a method of generating a project master plan, according to an embodiment of the present disclosure.

FIG. 4 is a flow diagram for a method for managing a project master plan, according to an embodiment of the present disclosure.

FIG. 5 diagrams an architecture of a PGMS, such as the PGMSs of FIGS. 1 and 2, respectively, for generating and managing a project plan for building a structure, according to an embodiment of the present disclosure.

FIG. 6 is a data diagram of a PGMS, according to an embodiment of the present disclosure.

### DETAILED DESCRIPTION OF PREFERRED EMBODIMENTS

A project, such as a building project, has many interrelated components to be coordinated. Coordinating the interrelated components and subprojects well can achieve efficiencies in time and resources and can lower costs. A build generally includes a building plan, or construction plan, comprising a variety of functions and demands addressed by tradespeople, such as heavy equipment operators, concrete specialists, framers, electricians, plumbers, and more. Each building plan typically requires the various trades to be performed, generally in a desired or a particular order, and to meet certain standards, in order to progress through the trades to completion of the project. Various payments of monies need to be made throughout the build process. Permits must be obtained, inspections must be scheduled (and paid). The present disclosure describes systems and methods that permit a client (a person desiring to build a project, such as a home) to select a building plan, for example, from a library of building plans. Each building plan may have associated to it a set of trades schedules (costs, timing), property specifications (e.g., requirements), and/or scheduling controls. The client can be assisted, where needed, in obtaining financing, procuring property suitable for a selected build plan, choosing contractors for various aspects of the build, automatically scheduling each tradesperson to be on site, providing for a variety of approvals to move the build forward, generate payment authorizations (e.g., draws) for payment at appropriate times and junctures of the build, requesting or scheduling inspections, and/or performing other functions to facilitate completion of the project from start to finish. The systems and methods herein disclosed can be used for a variety of project types including at least new construction of a building, rehabilitation of an existing building, add-on build (such as e.g., a pool at an existing home), and more.

The following description describes embodiments of the present disclosure with primary reference to systems and methods of generating and/or managing a residential home build. The reference to and focus on a residential home build is only an example, as a matter of convenience, and not by way of limitation as other applications, such as building rehabilitation, non-residential build, add-on build, etc., are also anticipated. Projects involving other structures (e.g., besides buildings) are also possible, such as road construction, bridge construction, tower (e.g., electrical, mobile communication) installation or construction, and/or any other improvement, enhancement, or other modification to a site that can involve multiple steps to complete.

The systems and methods herein described can include providing a plurality of build plans (e.g., a library of build plans) from which a client may select a build plan. Each build plan is, a priori, broken down into its component build jobs (e.g., trades jobs, subprojects). Contractors and tradespeople may be invited to provide proposals (e.g., bids) or more simply value data (comprising at least one or more of costs and scheduling) for each trades job relevant to the particular contractor or tradesperson. The value data for all trades jobs and subprojects can be related to each build plan having that particular trades job or subproject, and each build plan has associated with it a complete set of value data for the trades jobs and subprojects to complete that build plan. Each build plan also includes information related to property specifications (such as, e.g., minimum lot size, minimum lot dimensions, setbacks, zoning, slope, grade, etc.). The systems and methods herein described may assist, when needed, a client to obtain financing for purchasing property, and/or a construction loan, as well as conversion to a mortgage (or other post-build financial instrument); or to acquire (e.g., receive input) regarding financial data otherwise arranged by or for the client. The embodiments herein further schedule each contractor (e.g., trades person, sub) to be on site of the project based on a building sequence of the applicable build plan, and provides for work acceptance/approval as appropriate to ensure each successive building trade is able to proceed without delay and/or to ensure correction of deviations. The systems and methods herein may be used to issue “draws” (payment authorization) at appropriate times or on particular metrics (approval/acceptance of work, etc.) throughout the build. Permits may be acquired (including fee payment arrangements), official inspections scheduled (along with fee payment arrangement), etc. Where applicable, recordation may be facilitated.

As used herein, the term “floor plan” refers to a plan-view rendering of a structure (e.g., a building, outbuilding, add-on to a building, etc.) which, although it may include some construction information, may not be intended to be used for the performance of any trades services in construction, rehabilitation, renovation, etc. In other words, a floor plan is intended for use of an individual, such as a prospective homeowner, etc., lacking particularized training in individual construction trades, construction project management, etc.

As used herein, the term “construction plan” refers to a set of specifications or requirements for materials and performances to build a structure (such as, e.g., a residential building, a commercial office building, a warehouse, a sports facility, etc.), to rehabilitate or renovate a structure, to construct an add-on structure to an existing structure (such as, e.g., a garage, pool, etc., to a privately owned home, a parking structure to an office building, an outbuilding, etc.). A construction plan may include architectural and/or structural drawings, plumbing schedules, wiring schedules, lists of materials, etc., for use by individuals having particularized training in construction trades. A construction plan may be a building plan, an installation plan, a remodel plan, a removal project, a restoration effort, or the like.

As used herein, the term “inspection” refers to an examination performed by an independent party (such as may be designated by a zoning commission, board of governance, building code, etc.) of a portion of a project such as a construction job to ensure compliance with regulatory requirements.

As used herein, the term “review” refers to an examination performed by someone, typically someone other than who performed work under review, such as a tradesperson or by the owner (or an owner's designee), to ensure a satisfactory performance of work (e.g., an acceptance), typically before a succeeding job or sub-job is to commence. A review may also result in a rejection of the work, so that the reviewed work can be corrected or redone before a succeeding job or sub-job may commence.

As used herein, the term “master plan” refers to procedural functions to complete a building according to a construction plan and can include: acquisition of a site, such as building lot (or verifying suitability of a building lot for the particular building to be built), determination of a construction plan, pre-selecting a collection of trades relevant to the construction plan, selection of individual trades to work on the building, scheduling tradespersons (contractors, etc.) on site, providing for and implementing review and inspection schedules, managing review and inspection rejections, initiating timely payment of fees for services, and other functions related to completing the building and making it suitable for occupancy or other use. Acquisition of a site may include a number of financial functions, such as, e.g., assembling, collating, and/or submitting data intended to assist in procuring financing) A master plan can comprise a construction plan, and goes beyond the construction plan to all related functions and performances related to completing the building, such as to a user-occupiable state.

As used herein, the term “contractor” refers, generally, to an individual having particularized training in regards to a construction skill, or to a company (or other agency) providing such individuals, and is sufficiently broad to include any person performing a specialized task qualifying as a building trade as understood in the field of construction. Use of contractor is intended to include sub-contractors, employees, agents, etc., involved in a task falling under a particular trade in the field of construction.

As used herein, the term “trades” refers to the specialized skills and skilled-service providers often associated with the construction or building industry (construction trades) (e.g., heavy equipment operators, carpenters, framers, roofers, painters, electricians, etc.), as well as to providers of professional services (e.g., civil engineering, soils scientists, architects, land surveyors, electrical engineers), and the like. Said otherwise, “trades” refers to any person (real or legal) who may provide a service related to a construction plan, a build site, etc. Although reference may occasionally made to particular construction trades or professional service providers, this is for convenience of the disclosure and not by way of limitation.

As used herein, the term “user” refers to any authorized person who may electronically connect to a server of any of the embodiments herein disclosed. A user may be further identified herein by way of a descriptive adjective, such as, e.g., a project implementation user (also, “PI user”), an administrative user (also, “admin” or “admin user), a trades user, a finance user, an accounting user, a real property user, etc. By way of non-limiting examples, a PI user may be a person initiating a project (e.g., to build a residential house), an admin user may be an appropriate individual tasked with overseeing an operation or function of an embodiment, a trades user may be an electrical wiring contractor or a plumbing contractor, a finance user may be a representative of a lending institution, an accounting user may be a representative of bank charged with fulfilling draws, and a real property user may be a representative of a title company. When “user” appears without an adjective, the meaning should derive from context as referring to a PI user or to any other user.

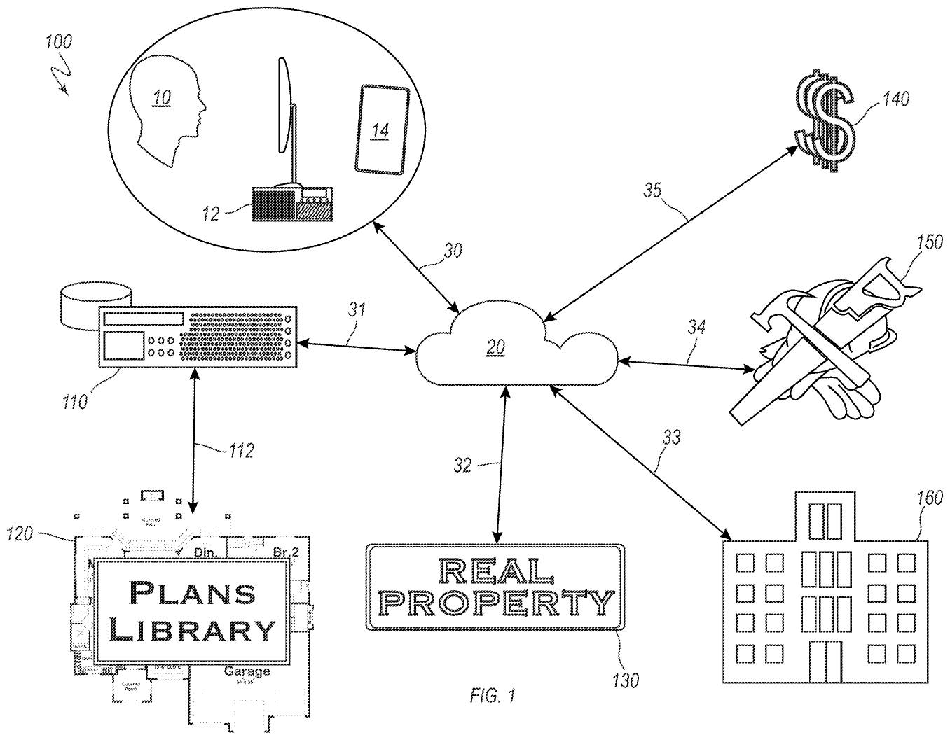

FIG. 1 is a diagram of a project generation and management system (“PGMS”) 100 for generating and managing a master plan for a project, according to an embodiment of the present disclosure. The PGMS 100 comprises a computing system (e.g., a “server”) 110. The server 110 may be a centrally located computing device, a plurality of interconnected computing systems (e.g., a distributed computing system), or other appropriate computing system. The server 110 has a bidirectional communication coupling 31 to an electronic communication network 20 such as the Internet. The PGMS 100 comprises a plans library 120. The plans library 120 may be stored at a memory (further described below) of the server 110 whereby the server 110 manages 112 the plans library 120. The server 110 of the PGMS 100 interacts with real property services 130, financial services 140, building trades services 150, and relevant governmental entities 160. The interactions of the server 110 with these services and entities 130-160 may be via the Internet 20 and bidirectional communication couplings 32-35, respectively. The server 110 of the PGMS 100 comprises internal subsystems, described below, to query, communicate with, acquire information from, make requests of the services and entities 130-160.

A user 10 may, using a computing device (such as, e.g., a desktop computer 12, a tablet computing device 14, etc.), access the server 110, via a bidirectional communication coupling 30 to the Internet 20, to use the PGMS 100. The user 10 may initiate a generation of a master plan for a building project (a project master plan, “PMP”) or project implementation data, such as for a structure (e.g., a home, a garage, an outbuilding, an office, etc.). In other words, the user 10 (in this instance, a PI user) may cause the PGMS 100 to generate a PMP. The user 10 may also interact with the PGMS 100 to use the various capabilities of the PGMS 100 to manage a PMP that has been generated. Said otherwise, the user 10 can use the PGMS 100 to generate (create) a new PMP and to execute and manage the PMP once generated.

To generate a new PMP, the user 10 may select a floor plan or construction plan from the plans library 120, may enter or upload data regarding a site (such as a lot already owned by the user) or may initiate an acquisition process (further described below) using the real property services 130, provide an estimated required date or actual required date (for completion of the project), provide an estimated a target total value (or cost) for completing the project, enter or upload financial data and may initiate financing services through the financial services 140, and select building trades associated to the selected construction plan and contractors from the building trades services 150. The selected construction plan may have associated to it (by a function of the server 110) inspection data. The inspection data can include a schedule of required (and recommended) inspections (e.g., when, in the build process, each inspection is to be performed, approval effect, rejection handling, etc.) and associated fees (e.g., initial fee, reinspection fee, certificate fee, etc.)

The real property services 130 may include entities to assist in acquiring real property (e.g., real estate brokerage, title company, etc.), an entity providing official metes and bounds (e.g., official property description, etc.) recordation and reporting (e.g., county recorder's office), etc. If the user 10 already owns a building lot, the user may enter or upload data regarding the building lot. If the user 10 needs to acquire a building lot, the PGMS 100 may provide to the user 10 an opportunity to select from a plurality of real estate brokering entities (“REB”), title companies, etc., and may initiate an interaction between the user 10 and each selected entity for facilitating the acquisition of a building lot. Such REBs, title companies, etc., may be real property users of the PGMS 100. By using the PGMS 100 to initiate a building lot acquisition, the user 10 ensures that the selected entities (real property users) involved in facilitating the acquisition are fully apprised of any relevant requirements springing from the construction plan selected by the user 10. A real property user may be authorized access to the PGMS 100 and to the particular PMP so as to receive and or provide relevant data. For example, the PGMS 100 provides to the selected real estate user information such as, zoning, minimum area (square foot, acreage, etc.) requirement, lot geometry requirement (if any), minimum lot side dimension(s) (if any), setback requirement or effect (if any), utility service access requirement, overhead clearance requirement (if any), ground stability requirements (permeability, composition, grade/grading, excavation potential, etc.), minimum/maximum frontage exposure (if any), etc. Furthermore, the real estate user may provide to the PGMS 100 all relevant data pertaining to an acquired building lot. The involvement at the PGMS 100 of the real property services 130, the PGMS 100 ensures compatibility of the selected construction plan and the build lot.

The PGMS 100 can acquire certain financial data in order to perform functions related to paying for services (of trades, etc.), materials, inspections, permits, etc. In an instance wherein the construction of the building is wholly paid for by the user 10, the user 10 may upload or enter the requisite financial data. If the user 10 has independently obtained financing from a financing company, the user 10, or an agent of the financing company may enter or upload the requisite data. In many instances, the user 10 will not have secured financing and will, instead, use the PGMS 100 to facilitate acquiring financing. The user 10 may enter some basic financial data to the server 110. The server 110 may provide a plurality of selections from which the user 10 may make a selection (or selections) in order to initiate interaction between the user 10 and one or member entities among the financial services 140. Once the user 10 has received financing approval, the particular financing entity among the financial services 140 may provide the remaining requisite financial information to the PGMS 100. In one embodiment, the particular financing entity may provide the user 10 additional data, which the user 10 can enter/upload to the PGMS 100. With regard to obtaining financing, the PGMS 100 may require from the user 10 information that may identify to the PGMS 100 lenders/financial entities appropriate for the user 10. The PGMS 100 can request or otherwise receive certain other data to enable the PGMS 100 to, in a timely manner, initiate draws (requests for payment), from the financial institution housing the funds for the construction and make other relevant disbursements (such as residual payout, if any).

In some embodiments, the PGMS 100 may be implemented as and/or referred to as a proposal coordination system to coordinate proposals for subprojects (e.g., trades) for implementing and otherwise accomplishing a project. In some embodiments, the PGMS 100 may also be implemented as and/or referred to as a project management system to accomplish a project.

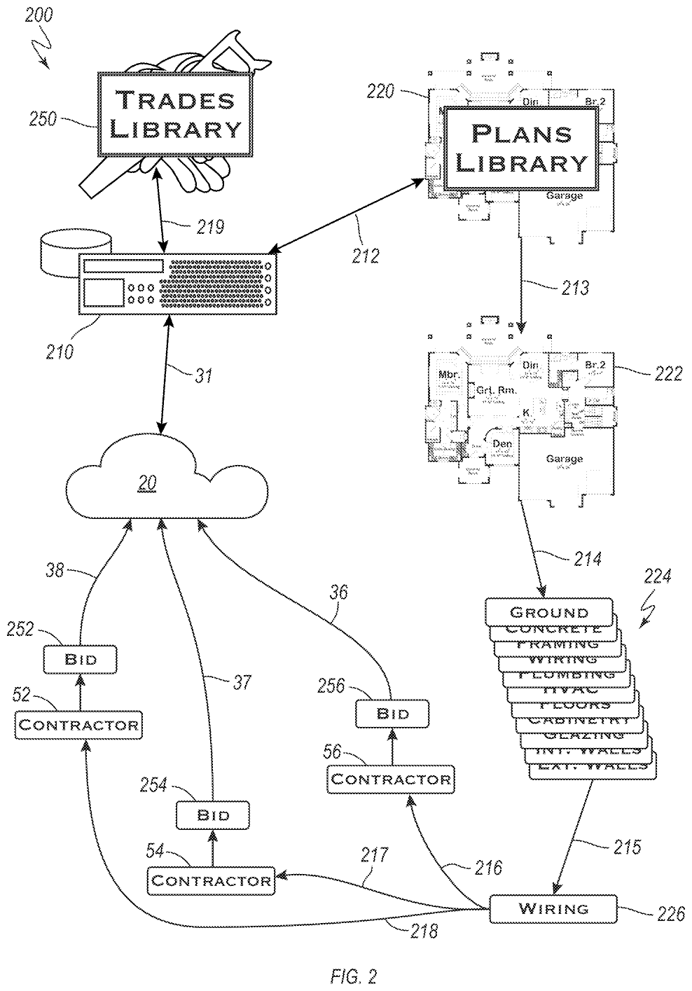

FIG. 2 depicts an embodiment of a project generation and management system (“PGMS”) 200, according to one embodiment. The PGMS 200 may resemble the PGMS 100 described above in certain respects, according to an embodiment of the present disclosure. Accordingly, like features are designated with like reference numerals, with the leading digit incremented to “2.” For example, the embodiment depicted in FIG. 2 includes a server 210 that may, in some respects, resemble the server 110 of FIG. 1. Relevant disclosure set forth above regarding similarly identified features thus may not be repeated hereafter. Moreover, specific features of the system 100 and related components shown in FIG. 1 may not be shown or identified by a reference numeral in the drawings or specifically discussed in the written description that follows; however, such features may clearly be the same, or substantially the same, as features depicted in other embodiments and/or described with respect to such embodiment. Accordingly, the relevant descriptions of such features may apply equally to the features of the PGMS 100 and related components depicted in FIG. 2. Any suitable combination of the features, and variation of the same, described with respect to the PGMS 100 and related components illustrated in FIG. 1 can be employed with the PGMS 200 and related components of FIG. 2, and vice versa. This pattern of disclosure applies equally to further embodiments depicted in subsequent figures and described hereafter, wherein the leading digit(s) may be further incremented.

FIG. 2 is a diagram of a project generation and management system (“PGMS”) 200, according to an embodiment of the present disclosure, and showing proposal (e.g., trades bid) management. The system 200 (e.g., the server 210) manages 212 the plans library 220. The plans library 220 comprises a plurality of construction plans. The server 210 processes each construction plan of the plans library 220 to identify, for each construction plan, the building trades and/or professional services to complete construction of a project according to that construction plan. By way of non-limiting example, the server 210 selects 213 a construction plan 222. The server 210 may select 213 the construction plan 222 based on input, such as from a project implementation user. The construction plan 222 indicates 214 a plurality of building trades 224 for completion. In other words, a number of different building trades 224 may be involved in construction of the house detailed in the selected construction plan 222. The server 210 selects 215 a first building trade 226 and identifies each contractor previously associated to the PGMS 200. A contractor may be invited to associate to the PGMS 200, or may apply to associate to the PGMS 200. The PGMS 200 may provide a set of requirements and/or qualifications (e.g., licensure, insurance, etc.) a contractor should meet in order to associate to the PGMS 200. In the instant example, for the selected building trade 226, three contractors 52, 54, 56 are associated to the PGMS 200. These three contractors 52-56 are trades users of the PGMS 200. The PGMS 200 may notify each of the contractors 52-56 regarding the particular jobs of the building trade 226 needed for implementing the construction plan 222. In one embodiment, a contractor 52-56 may log into the PGMS 200 and search for jobs under the contractor's particular trade (which may produce results for multiple construction plans). Each contractor 52-56 is provided the details of the job(s) for the building trade 226 as indicated for the construction plan 222.

Each contractor 52-56 may generate a bid 252, 254, 256 (e.g., a proposal to complete a subproject), respectively, reflecting value data to perform the job(s). Value data may comprise cost data and/or schedule data. Cost data may include costs of materials, supplies, labor, etc. Materials and supplies costs may be consolidated, where appropriate, or listed by individual item, as appropriate. Labor costs may be treated as a per job cost, per sub-job cost, or an hourly rate, etc. The schedule data may comprise a duration for the completion of the job, or each sub-job. In one embodiment, the schedule data may further comprise a dependency such that the job of the bid requires completion of some other job (in the same or another building trade). The schedule data may be augmented with dependency requirements from another source, such as, e.g., standard practice, building code, etc. Each contractor 52-56 submits a bid 252-265, responsive to the requirements of the construction plan 222, via a bidirectional communication connection 36, 37, 38, respectively, through the Internet 20 to the server 210 using the bidirectional communication coupling 31.

The PGMS 200 (e.g., the server 210) may associate each bid 252-256 (e.g., a proposal, value data) to the particular job of the particular construction plan. In one embodiment, the server 210 may associate each bid 252-256 to a plurality of construction plans wherein the associated job is identical. By way of example without limitation, if the plans library 220 has multiple construction plans 220 having the same kitchen layout, cabinetry requirements, countertop requirements, etc., a bid 242-256 to provide cabinetry for the kitchen of the particular construction plan 222 may be associated to each other construction plan having the same cabinetry requirements. This permits the server 210 to associate a single bid (related to a building trades job) for a first construction plan to other construction plans having the same trades job requirement; and a contractor 52-56 is not required (but may choose) to individually enter bids for each construction plan having the same building trades job requirement. All bid submissions become part of a trades library 250 managed 219 by the server 210. Each contractor for each trade becomes part of the trades library 250. More particularly, the trades library 250 serves to associate contractors, bid value data, and bid schedule data to each identical building trades job throughout the plans library 220. The association of bids to jobs of plans in the plans library 250 permits the PGMS 200 to use value data and schedule data of bids in coordinating and subprojects of a project and otherwise pricing and scheduling such project. As will be apparent, a bid associated to a construction plan may be provided to a PI user selecting the plan for another PMP. (Likewise, a PI user who is, for example, a developer, may select a plan for multiple inclusion in a tract-wise PMP, etc.). For each such PMP (or multiple inclusion in a PMP), the PMGS 200 enables the given PI user to select among each of the bids associated to the construction plan. In other words, the bid 242 of a contractor 52 is available for selection in each PMP wherein the associated construction plan is selected.

The providers of real property services 130, and financial services 140 may be associated to the PGMS 100 in FIG. 1 in a manner similar to that described for contractors (building trades services 150) in conjunction with FIG. 2.

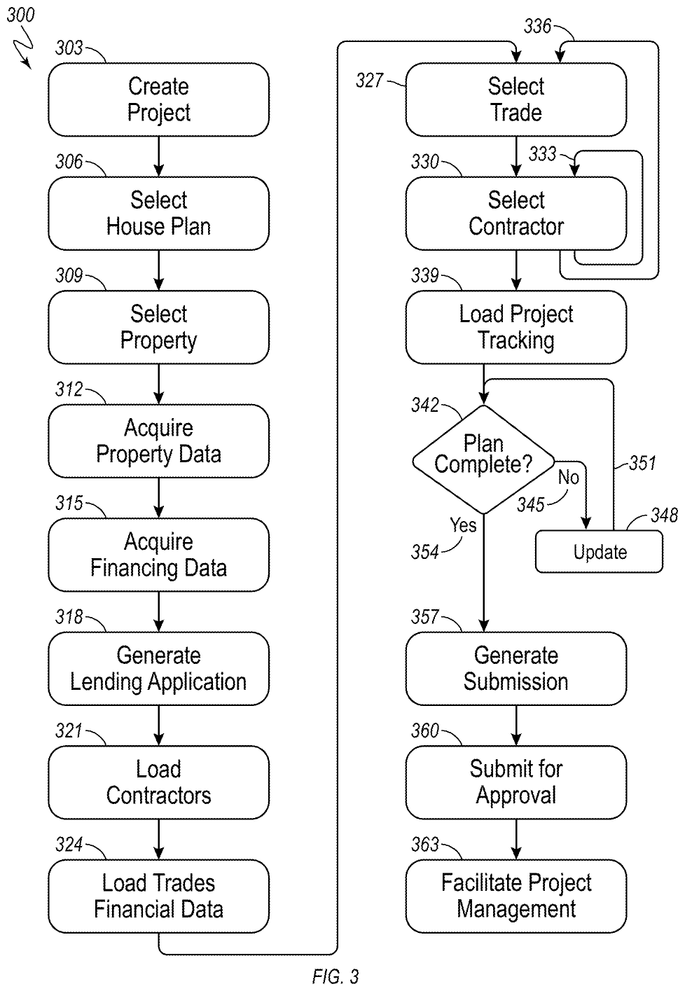

FIG. 3 is a flow diagram for a method 300 of a project generation and management system (“PGMS”), such as the PGMSs 100, 200 of FIGS. 1 and 2, for generating a project master plan, according to an embodiment of the present disclosure. The method 300 is described as using each function of the PGMS. In some instances, one or more functions may be altered or omitted. Furthermore, reference is made to a house as a building, the construction of which is to be managed by the PGMS. Another building, e.g., a commercial building, an outbuilding, a pool, a tower, a bridge, etc., may likewise be the subject of the method 300. A user of the PGMS creates 303 (e.g., initiates PGMS creation of) a project. Said otherwise, the user initiates generation of a PMP. The PGMS may present a search interface that the user may employ to enter one or more parameters related to the house the construction of which is to be managed by the PGMS. The user selects 306 and the PGMS receives selection of a house plan. More particularly, the user may choose to have the PGMS present floor plans or construction plans from which the user may select a house plan. The user of the PGMS selects 309 (and the PGMS receives a selection of) a property (e.g., a building lot). Selection 309 of a property may take the form of the user denoting ownership of building lot owned by the user, or may entail choosing one or more parameters for a property to be acquired. The PGMS may applying any requirements that may be imposed by the selected house plan. Alternatively or in addition, the PGMS may apply any requirements imposed by the selected property (e.g., ensuring that the house plan is compatible with the selected property). Once a property is available (owned or identified for purchase), the given property data are acquired 312.

Financing data can be acquired 315 or otherwise received. The financing data may comprise information needed to apply for a construction loan and/or for a conversion to a mortgage loan. If appropriate, a lending application is generated 318. The lending application may comprise at least a portion of the property data, and data otherwise needed to facilitate applying for and obtaining a loan. In one embodiment, a plurality of lenders may be presented to the user, and, upon receiving a selection of a lender, the PGMS either facilitates contact between the user and the lender, or the PGMS generates loan application package based on package data from the lender and borrower data from the user. If the user has already secured financing outside the PGMS, the user may be prompted to upload appropriate data and/or documents to enable to the PGMS to manage draw requests and provide accounting.

The PGMS loads 321 contractor data for each contractor having a bid (e.g., proposal, value data) in the trades library relevant to the selected house plan. The PGMS loads 324 trades financial data to each of the contractors. With the contractors and trades financial data loaded, the PGMS presents to the user an opportunity to select 327 one of the construction trades associated with the selected house plan. The PGMS presents to the user an opportunity to select 330 a contractor associated to the selected construction trade. The PGMS may present a contractor for selection 330 based on availability, pricing filters, and/or other criteria. In some cases, one or more contractor bids may offer a degree of customization or options selection. For example, a choice of wood for cabinetry may be available, a choice of countertop material and/or finish may be available. The user is able to review such options, where they are offered, for each contractor. The user makes any options choices, and the PGMS is able to track any changes to job costs and overall budget impact. The PGMS iterates 333 through the contractor selection for each contractor in the particular construction trade. The PGMS also iterates 336 through trades selections. The PGMS loads 339 project tracking. An initial load 339 of the project tracking may be a blank schedule matrix. While iterating 333, 336 through contractor and trade selections, the schedule matrix may be populated according to job priority, duration, etc., to create a schedule for the PMP. In other words, each job may be scheduled according to which job or jobs should precede a particular job. The PGMS may use the project tracking, more particularly a schedule, to ensure at least one contractor is selected for each job of each construction trade associated to the selected house plan. The PGMS may also use the project tracking to initially schedule all jobs, considering any dependencies, such as, e.g., framing completion prior to wiring commencement, etc. The user may exit the PGMS at any time, and the PGMS saves all work and data acquired to the time of user exit, and is able to reload at the same point of the method 300 when the user reconnects to the PGMS. In other words, if a user has not finished selecting all the contractors for the house plan, the PGMS makes record of all selections that have been made and is able to resume at the point of the user's exit.

The PGMS further checks 342 whether the plan is complete. If no 345, the PGMS proceeds or updates 348 to a point in the method 300 where an incomplete status exists. When some action is taken to address the incompleteness, the PGMS returns or iterates 351 to check 342 again whether the plan is complete. When, yes 354, the plan is complete, the PGMS generates 357 a submission package. The submission package may be reviewed by a project implementation user, such as for acceptance or approval. The submission package may be used to request permits and approval from a governing body (e.g., of a county, etc.) of the plan. The PGMS may submit 360 the completed plan to the governing body for approval. The PGMS may also facilitate remittance of any fees required to obtain approval of the governing body. The PGMS may also acquire and store, at a memory of the PGMS, the received approval, and may facilitate printing any certificate or other documentation that may be required, for example, e.g., construction notices required to be posted at the site. The PGMS then facilitates 363 project management, as further described below, to completion of the build.

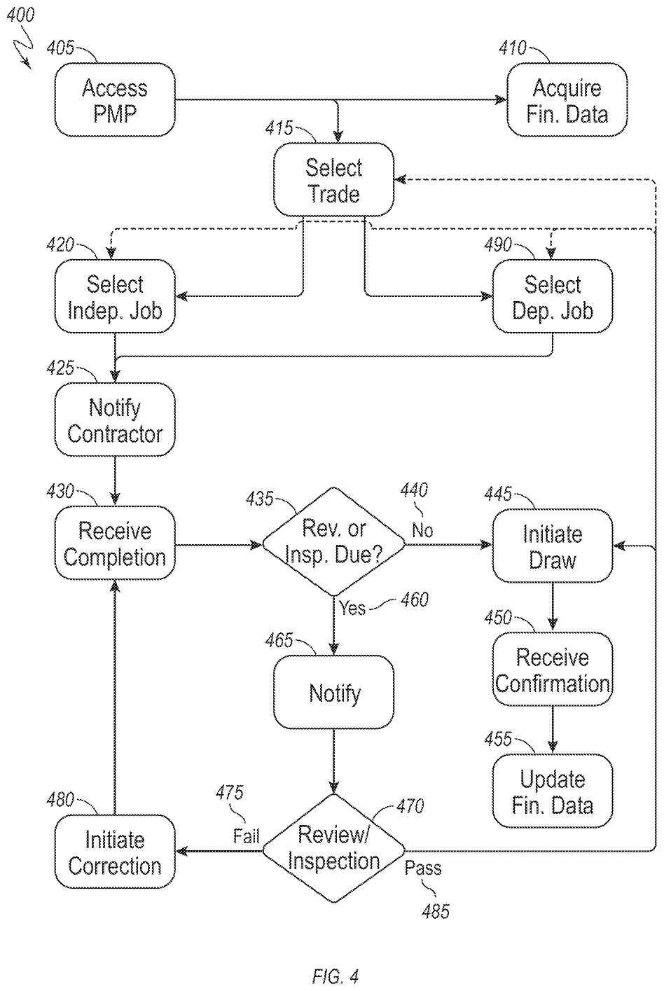

FIG. 4 is a flow diagram for a method 400 of a project generation and management system (“PGMS”), according to an embodiment of the present disclosure, such as the PGMSs 100, 200 of FIGS. 1 and 2, for managing a project master plan (“PMP”), such as a PMP generated by the method 300 of FIG. 3. The PGMS receives a selection of and/or otherwise accesses 405 a PMP. The PGMS acquires 410 financial data to be able to issue draw requests, such as, information regarding a financial institution responsible for making payments for services, materials, fees, etc., associated with performance or implementation of the PMP. This particular financial data may be absent from the PMP when the PMP is accessed 405 the first time. The PGMS selects 415 a construction trade according to the schedule for the PMP. The PGMS may select 420 an independent job or may select 490 a dependent job from the schedule matrix. The schedule matrix for the particular PMP may indicate or even require a land survey before (or in order to) perform grading and surface stabilization. A land survey is an example of an independent job, depending from no preceding job. Grading and surface stabilization may be independent jobs in one PMP, or dependent jobs in one PMP. In contrast, wiring of a new construction house is a dependent job, requiring framing (or other wall-build process) to be completed before wiring can commence.

The PGMS notifies 425 the contractor for the selected job (or jobs, when multiple jobs can run in parallel) to commence work according to schedule. The PGMS may also advance-notify a contractor for a succeeding job to provide for needed lead time (such as, e.g., to acquire or deliver materials, etc.). The contractor performs the job and provides notification of completion. The PGMS receives 430 notice of completion of the particular job. The PGMS determines 435 if a review or an inspection is needed for the completed job. A review may be an approval of a project implementation user (e.g., homeowner). A review may be an approval of a subsequent contractor that the project is in condition to begin a next trade job/sub-job. For example, the review may be a clear path review that comprises a questionnaire (physical or electronic form) to verify one or more of: jobsite clean; pad is square; bolts correctly positioned; hurricane straps applied; plumbing correctly placed; etc. If no 440, a review or inspection is not required, the PGMS initiates 445 a draw for payment of the contractor and any separately payable materials, etc., related to the particular job. If yes 460, a review of inspection is needed, the PGMS notifies 465 the person or entity to provide the review or inspection. A review may be completed by an owner or owner-designee, a supervisor, a contractor of a succeeding job depending from the job to be reviewed. An inspection may be an examination by a third party in accordance with a regulation or other requirement, such as may be imposed by a building code. In many instances, when an inspection is needed, a review is not. In some instances, it is desirable to perform a review prior to an inspection. Such preferences and requirements may be included in the PMP during generation of the PMP. The PGMS, when notifying 465 for, in particular, an inspection, may propose or request an inspection appointment, and add such appointment to the schedule matrix. Once the review or inspection is completed 470, the PGMS receives notification of the outcome. If the review or inspection results in a fail (the reviewed/inspected work is unsatisfactory or out of compliance) 475, the PGMS initiates 480 correction of the defective work. If required for a failed inspection, the PGMS may initiate 445 a draw for payment of an inspection fee. Once the work has been corrected, the PGMS again receives 430 notice of completion. If the result of the review or inspection is pass (the work is acceptable or in compliance) 485, the PGMS may initiate 445 a draw for payment.

The PGMS further proceeds, according to the scheduling matrix of the PMP, to select 415 a construction trade, or to select 420, 490, respectively, an independent or dependent job. The PGMS iterates through this method to completion of the PMP. At various times or steps throughout the method 300, the PGMS may update the schedule as needed. By way of non-limiting example, a contractor finishes a job ahead of schedule and notifies the PGMS. The PGMS may advance the schedule, if feasible in view of other jobs and availability. Similarly, if an inspection results in a rejection, the PGMS may adjust the schedule to permit correction of the defect causing the rejection and permit re-inspection after remediation.

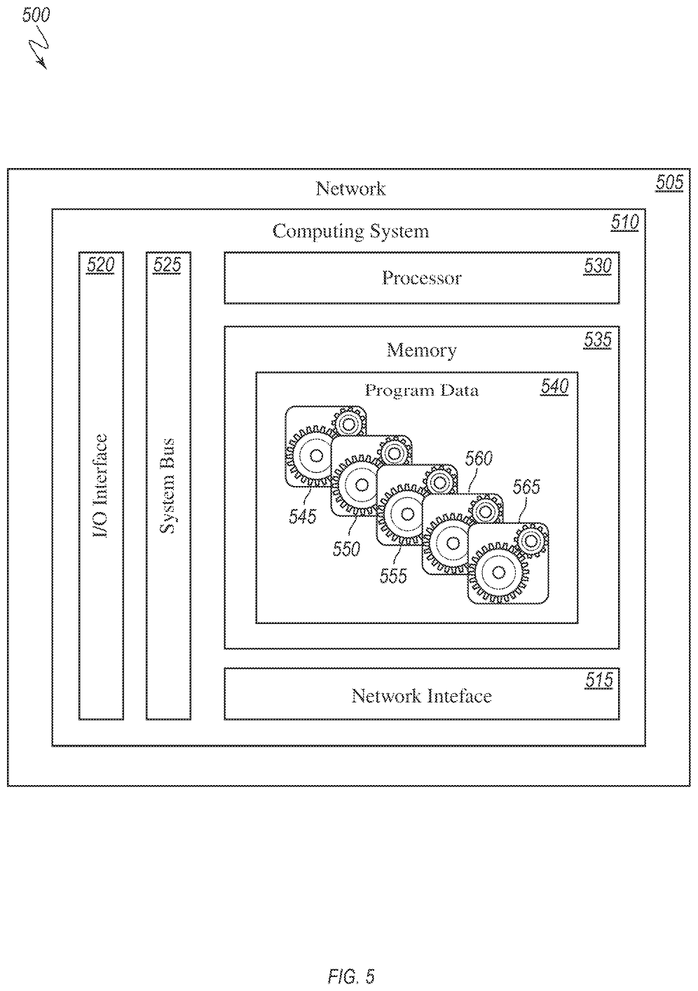

FIG. 5 diagrams an architecture of a project generation and management system (“PGMS”) 500, such as the PGMS 100, 200 of FIGS. 1 and 2, respectively, for generating and managing a project plan for building a structure, according to an embodiment of the present disclosure. The PGMS 500 includes a computing system 510, hereafter referred to as a server 510, that may be similar in some respects to the PGMS server 140 of FIG. 1. The PGMS 500 comprises a network 505, and the server 510. While the description suggests the server 510 is a single computing system, the present disclosure anticipates that the server 510 may comprise a distributed computing system, etc. The server 510 includes a system bus 525, one or more processors 530, an electronic memory 535, an input/output interface (I/O interface) 520, and a network interface 515. The PGMS 500 may include and/or connect with a client computing device over the network 505 via the network interface 515.

The one or more processors 530 may include one or more general purpose devices, such as an Intel®, AMD®, or other standard microprocessor. The one or more processors 530 may include a special purpose processing device, such as ASIC, SoC, SiP, FPGA, PAL, PLA, FPLA, PLD, or other customized or programmable device. The one or more processors 530 may perform distributed (e.g., parallel) processing to execute or otherwise implement functionalities of the present embodiments. The one or more processors 530 may run a standard operating system and perform standard operating system functions. It is recognized that any standard operating systems may be used, such as, for example, Microsoft® Windows®, Apple® MacOS®, Disk Operating System (DOS), UNIX, IRJX, Solaris, SunOS, FreeBSD, Linux®, ffiM® OS/2® operating systems, and so forth.

The electronic memory 535 may include static RAM, dynamic RAM, flash memory, one or more flip-flops, ROM, CD-ROM, DVD, disk, tape, or magnetic, optical, or other computer storage medium. The electronic memory 535 may include a plurality of program modules 545-565 and a program data 540. The electronic memory 535 may be local to the server 510 or may be remote from the server 510 and/or distributed over the network 505.

The program modules 545-565 may include all or portions of other elements of the PGMS 500. The program modules 545-565 may run multiple operations concurrently or in parallel by or on the one or more processors 530. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, cause a computing system to implement certain processing steps, procedures, and/or operations, as disclosed herein. The modules, components, and/or facilities disclosed herein, may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like.

The program data 540 stored on the electronic memory 535 may include data generated by the PGMS 500, such as by the program modules 545-565 or other modules. For example, the program data may include plan records, proposal records, and the like. The stored program data 540 may be organized as one or more databases.

The I/O interface 520 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network interface 515 may facilitate communication with other computing devices and/or networks 505, such as the Internet and/or other computing and/or communications networks. The network interface 515 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM), etc. Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 525 may facilitate communication and/or interaction between the other components of the PGMS 500, including the one or more processors 530, the electronic memory 535, the I/O interface 520, and the network interface 515.

As noted, the PGMS 500 includes various program modules 545-565 (or engines, elements, or components) (hereafter, “modules”) to implement functionalities of the PGMS 500 and to generate, access, and/or manipulate the program data 540 stored in the electronic memory 535. Each of the various modules 545-565 may comprise machine-readable instructions that may be read and used by the one or more processors 530 to perform various functions of the PGMS 500. The modules 545-565 can include a construction plans parsing module (“CPM”) 545, a property parsing module (“PPM”) 550, a bids management module (“BMM”) 555, a financials module (“FM”) 560, a schedule module (“SM”) 565, and other appropriate software modules. There may be more or fewer software modules 545-565 than shown in FIG. 5 and described herein.

The processor 530 is configurable to enable the processor 530 to read and execute computer-executable instructions, such as computer-executable instructions to perform the methods described herein. The computer-executable instructions may be stored in the memory 535, or in another memory accessible to the processor 530. The I/O interface 520 and/or the network interface 515 may enable to processor 530 to communicate with the memory 535 and/or another memory, and to communicate with, for example, a tablet computer, such as the tablet computing device 14 of FIG. 1. The memory 535 may store computer-readable and executable instructions to enable the processor 530 to perform the methods described herein. More particularly, the memory 535 may store instructions to enable the processor 530 to operate the CPM 545 to parse each construction plan into its component construction trades and trades jobs and sub-jobs; to identify dependencies (order of build requirements, etc.), material requirements (e.g., code requirements, default option in plural option cases, etc.), etc. The CPM 545 may also enable the processor 530 to acquire construction plans (such as, e.g., over the network interface 515, the i/o interface 520, the system bus 525, etc.), store construction plans at a plans library, update/modify construction plans, to delete construction plans from the plans library, etc. The CPM 545 may further enable the processor 530 to activate or employ one or more other modules 550-565. By way of non-limiting examples, the CPM 545 may identify requirements for a building lot and enable the processor 530 to employ the PPM 550, and/or may provide data needed for operation of the FM 560, and/or provide data needed to properly order trades and jobs for use with the SM 565.

The PPM 550 may enable the processor 530 compile a library of known available building lots, and may further enable proper (or options for proper) placement of a structure according to selected construction plan to a building lot, may provide for determination of some services and/or trades jobs (such as, e.g., to determine which, if any, surface grading may be required, etc.). The PPM 550 may further access public records to determine location of a building lot relative to utility services, etc., and may employ such data to facilitate scheduling (by the SM 565) of connection to utility services, fees, etc. The PPM 550 may generate or access property-related costs to be provided for use of the FM 560. The BMM 555 may enable the processor 530 to by use of the network interface 515 communicate with potential contractors, to provide potential contractors with detailed data of jobs of a contractor-relevant construction trade, any schedule requirements, etc.; and to receive from one or more contractors a bid for one or more jobs or sub-jobs, a bid responsive to the requirements delivered by the processor 530 over the network interface 515 and including value data and schedule data. Value data may comprise a base cost for the particular job of the bid, a detailed cost breakdown, a default selection in the case of a multiple-option job (such as a default material and alternate materials for kitchen cabinetry), cost data for each option in the case of a multiple-option job, a labor cost (if required to be provided separately from materials cost), and any other costs for completion of the particular job. Value data may further comprise payment details to permit to enable the FM 560, at appropriate times, to generate draws to pay the contractor once the job is finished and accepted. Schedule data comprises at least a duration for completion of the job, and may also comprise any lead time for notifying the contractor as to job start (to ensure availability of the contractor, provide time for procurement and/or delivery of materials, etc.). Schedule data may further include dependency data (identifying any job that should be completed, or partially completed, before the particular job of the bid may be started). The BMM 555 also enables the processor 530 to receive, over the network interface 515, each bid from each contractor, and to parse the bid into financial and schedule components for use, respectively, of the FM 560 and the SM 565. Additional other modules are anticipated by the present disclosure.

The FM 560 may enable the processor 530 to compile and organize various financial data, and to implement or execute related financial functions. The FM 560 enables the processor 530 to receive, via the network interface 515, from the user particular financial data that may be used to facilitate obtaining a construction loan and/or conversion to a mortgage. The FM 560 enables the processor 530 to receive from one or more of the CPM 545, the PPM 550, and the BMM 555 data related to costs of materials, services, fees, etc. The FM 560 enables the processor to acquire, for use of the FM 560, data related to initiating draws, including payor data and payee data. The FM 560 may enable to processor 530 to generate a draw for payment of a service, job, fec, etc., based on data received via the SM 565 indicating completion of the payable service, job, fee, etc. The SM 565 may enable the processor to acquire data related to scheduling the performance of each job, service, inspection, etc. More particularly, the CPM 545, construction practices, code requirements, etc., may be used to establish an order of performance, and a timing of performance for each service, job, inspection, etc. The PPM 550 may provide particular data affecting scheduling of services, jobs, inspections, etc., such as, e.g., a need to remove overburden, grade the building lot, provide stabilization, affect any excavation to be performed, etc. The BMM 555 may provide particularized data regarding how long each job is expected to take to complete, to provide any dependency requirement, to set out any lead time for a particular job, etc. The BMM 555 may also enable the processor 530 to receive, over the network interface 515 and from the user of the PGMS, a rating/review of each contractor or contractor's performance. The SM 565 may enable the processor 530 to generate a timetable schedule for all functions, performances, services, etc., to complete building of the house from start to finish. The SM 565 may further enable the processor 530 to, via the network interface 515, timely send appropriate notifications to contractors, inspectors, the property owner, and any other designated person or entity as warranted by the particular notification. The SM 565 may further enable the processor 530 to identify deviations (such as, e.g., a contractor delay, an inspection failure, etc.) from schedule and to make appropriate adjustments to the schedule. In one embodiment, all (or some) communication of various notifications and/or completions may be enabled by means of another module. Additional modules are anticipated by the present disclosure, such as to enable the processor to perform other functions, or to provide for some of the above-described functions via multiple modules.

The network interface 515 may enable communication of the results generated by the modules 545-565 to a memory for retention storage and/or communication to another system.

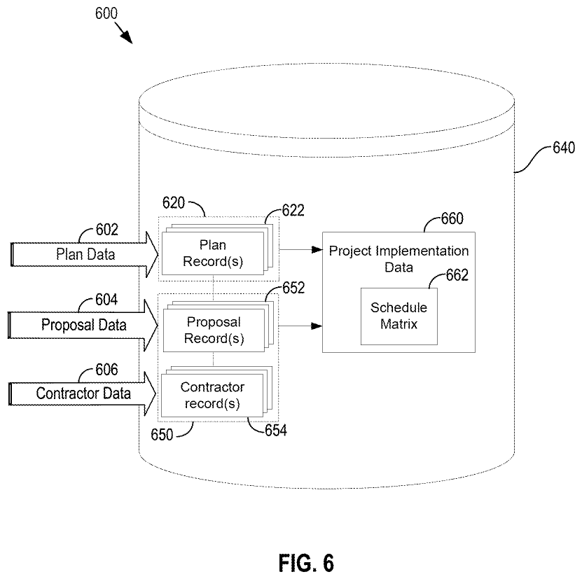

FIG. 6 is a data diagram of a PGMS 600, according to an embodiment of the present disclosure. The PGMS 600 may resemble the PGMS 100, the PGMS 200, and/or the PGMS 500 described above in certain respects, according to an embodiment of the present disclosure. As indicated above, program modules may generate program data. FIG. 6 illustrates program data 640, according to one embodiment. Plan data 602 is received and can be used to create plan records 622. The plan data 602 provides information for a plan for implementing a project, such as building a structure. The plan data 602 outlines the subprojects to complete the project. The plan records 622 can be included in a plans library 622, such as the plans library 120 of FIG. 1 and/or the plans library 220 of FIG. 2. Contractor data 606 can be received for contractors that desire to be associated to the PGMS 600 and can provide contractor data 606 to register or otherwise associate with the system. The contractor data 606 may be used to create contractor records 654. Contractors associate with the system to provide proposal data 604 (e.g., bids). The proposal data 604 can provide information for a proposal (e.g., a bid) for performing a subproject of a project, including cost data and timing/scheduling data. The proposal data 604 can be used to generate proposal records 652. The proposal records 652 can be associated with a contractor record 654. The contractor records 654 and associated proposal records 652 can be included in a trades library 650, such as the trades library 250 of FIG. 2. The contractor records 654 can also be used to store contractor performer data indicating how well a contractor abides by proposals and/or timely completes projects according to project implementation data (e.g., a schedule).

The PGMS 600 can use the plans library 620 and trades library 650 to generate project implementation data 660, such as a PMP as described above. The PGMS 600 may utilize the plan records 622, the proposal records 652, and/or the contractor records 654, according to user input, to generate project implementation data 660. The proposals can be scheduled into a schedule matrix 622, which may be included in the project implementation data 660, to schedule order and/or timing of contractors to complete subprojects according to proposals and toward completing the project. The PGMS can consider proposal cost data and/or scheduling data, as well as contractor availability data to generate the project implementation data 660.

It should be noted that, while the foregoing embodiments primarily make use of an example of building a residential home, this is for convenience of disclosure only, and not by way of limitation. The present disclosure anticipates application to a variety of project types, such as, and not limited to, renovating a residential home, building or renovating a multifamily residential structure, building or renovating an office (or other business) structure, extending an existing structure, moving or extending utility services (e.g., power transmission towers, cell towers, gas lines, etc.), construction or repair (or reconstruction) of a road, bridge construction or repair, removal or destruction of a structure, rehabilitation of site (such as, e.g., to make suitable for a purpose, restore to a natural state, etc.), etc.

### EXAMPLES

Some examples of embodiments of the present disclosure are now provided.

Example 1. A proposal coordination system to coordinate proposals to accomplish a project, comprising: a memory and one or more processors in electrical communication with the memory and to receive and transmit data via a network interface, the memory and processors to: receive plan data for a plan for a project to be accomplished, the plan data including information for a plurality of subprojects of the project; creating a plan record in the memory, the plan record including the plan data; receive, over the network, one or more proposals for reach of the plurality of subprojects, a given proposal provided by an intended performer to complete the corresponding given subproject of the project, the proposal including value data for completing the subproject and timing data that includes at least one of a duration for completing the subproject and a schedule of tasks for completing the subproject; create a proposal record in the memory for reach of the one or more proposals, the proposal record associated with the plan record; provide, over the network to a user, at least one of the project or the plan for selection by the user; receive, over the network, project selection input from the user indicating the at least one of the project or plan; provide, over the network to the user, proposals corresponding to the plan; receive, over the network, proposal selection input from the user indicating a set of proposals to accomplish the project according to the plan, the set of proposals including a proposal for each subproject of the plurality of subprojects of the project; generate project implementation data based on the set of proposals, the project implementation data including a total value based on the value data of the set of proposals and an implementation schedule coordinating timing of implementation of the subprojects of the set of proposals based on the timing data; and provide, over the network to the user, the project implementation data for acceptance by the user.

Example 2. The system of Example 1, the memory and the one or more processors further to: receive, over the network from the user, acceptance data indicating acceptance of the project implementation data; and provide, over the network to the intended performer of each subproject of the set of subprojects, one or more of indication of the acceptance of the proposal for the subproject and at least a portion of the implementation schedule corresponding to the subproject.

Example 3. A project management system to accomplish a project, comprising: a memory and or more processors in electrical communication with the memory and to receive and transmit data via a network interface to communicate over a network, the memory and one or more processors to: receive, from a user via the network, a selection of a plan for a project to be accomplished, at least one of an estimated date and a required date, and a target total value of the project; access plan data for the selected plan, the plan data including information for a plurality of subprojects of the project; access proposals associated with each subproject of the plurality of subprojects of the project, the proposals each provided by a performer that intends (or offers) to complete the subproject and each including value data for completing the subproject and timing data that includes at least one of a duration for completing the subproject and a schedule of tasks for completing the corresponding subproject; determine, based on timing for performing the plurality of subprojects, one or more of an implementation schedule and an estimated required date; access performer data of the performer of each of the proposals to determine performer availability relative to one or more of a timeframe of the project, the estimated required date, the implementation schedule, and a target total value of the project; receive, over the network, proposal selection input from the user indicating a set of proposals to accomplish the project according to the plan, the set of proposals including a proposal for each subproject of the plurality of subprojects of the project; provide, over the network to the performer of each proposal of the set of proposals, one or more of notification of the acceptance of the proposal for the subproject and at least a portion of an/the implementation schedule corresponding to the subproject; for each subproject of the plurality of subprojects: receive, over the network, completion data providing indication that the performer completed the subproject; receive, over the network, an acceptance of the subproject from the user; determine if an inspection by an independent inspector is required; transmit, over the network, an inspection request to the independent inspector; receiver inspector acceptance of the subproject; determine a next subproject and a corresponding next performer, based on the implementation schedule; alert, over the network, a next performer that a next subproject is set to begin; receive a clearpath approval from the next perform that the subproject is complete; initiate a payment based on the proposal of the performer.

Example 4. The system of example 3, wherein the memory and one or more processors are further to: receive site data providing information about a site at which the project is to be accomplished; provide, over the network to the user, site feedback information for the site.

Example 5. The system of example 4, wherein the site feedback information comprises one or more of property compatibility information for a property on which the project is to be implemented, property purchase information and property ownership evidence.

Example 6. The system of example 3, wherein the memory and processors are further to: receive financing data providing information about financing for the project, the financing data including a financing budget for the project; and determine compatibility of the financing budget and the project.

It will be obvious to those having skill in the art that many changes may be made to the details of the above-described embodiments without departing from the underlying principles of the invention. The scope of the present invention should, therefore, be determined only by the following claims.

1. A proposal coordination system to coordinate proposals to accomplish a project, comprising:
a memory and one or more processors in electrical communication with the memory and to receive and transmit data via a network interface to communicate over a network, the one or more processors to execute instructions to cause the system to:
receive plan data for a plan for a project to be accomplished, the plan data including information for a plurality of subprojects of the project;
create a plan record in the memory, the plan record including the plan data;
receive, over the network, one or more proposals for each of the plurality of subprojects, each proposal provided by an intended performer to complete the corresponding subproject of the project, the proposal including value data for completing the subproject and timing data that includes at least one of a duration for completing the subproject and a schedule of tasks for completing the subproject;
create a proposal record in the memory for each of the one or more proposals, wherein the proposal record is associated with the plan record;
provide, over the network to a project implementation user, at least one of the project or the plan for presentation to and selection by the project implementation user;
receive, over the network, project selection input from the project implementation user indicating the at least one of the project or the plan corresponding to the project;
provide, over the network to the project implementation user, proposals corresponding to the plan;
receive, over the network, proposal selection input from the project implementation user indicating a set of proposals to accomplish the project according to the plan, the set of proposals including a proposal for each subproject of the plurality of subprojects of the project;
generate project implementation data based on the set of proposals, the project implementation data including a total value based on the value data of the set of proposals and an implementation schedule coordinating timing of implementation of the subprojects of the set of proposals based on the timing data; and
provide, over the network to the project implementation user, the project implementation data for acceptance by the project implementation user.

2. The system of claim 1, the one or more processors further to:
receive, over the network from the project implementation user, acceptance data indicating acceptance of the project implementation data; and
provide, over the network to the intended performer of each subproject of the set of subprojects, one or more of indication of the acceptance of the proposal for the subproject and at least a portion of the implementation schedule corresponding to the subproject.

3. The system of claim 1, the one or more processors further to:
for each subproject of the plurality of subprojects:
receive, over the network, completion data providing indication that the performer completed the subproject;
receive, over the network, an acceptance of the subproject from the project implementation user;
alert, over the network, a next performer that a next subproject is set to begin;
receive a clearpath approval from the next performer that the subproject is complete; and
initiate a payment based on the proposal of the performer.

4. The system of claim 3, wherein the one or more processors are further to:
for each subproject of the plurality of subprojects:
determine the next subproject and a corresponding next performer, based on the implementation schedule.

5. The system of claim 1, wherein the one or more processors are further to:
determine if an inspection by an independent inspector is required;
transmit, over the network, an inspection request to the independent inspector; and
receive inspector acceptance of the subproject.

6. The system of claim 1, wherein the implementation schedule coordinates performer availability.

7. The system of claim 1, wherein the one or more processors are further to:
receive site data providing information about a site at which the project is to be accomplished;
generate site feedback information based on the plan data; and
provide, over the network, the site feedback information for the site.

8. A project management system to accomplish a project, comprising:
a memory and one or more processors in electrical communication with the memory and to receive and transmit data via a network interface to communicate over a network, the one or more processors to execute instructions to cause the system to:
receive, via the network from a project implementation user, a selection of a plan for a project to be accomplished;
access plan data for the selected plan, the plan data including information for a plurality of subprojects of the project;
access proposals associated with each subproject of the plurality of subprojects of the project;
receive, over the network, proposal selection input from the project implementation user indicating a set of proposals to accomplish the project according to the plan, the set of proposals including a proposal for each subproject of the plurality of subprojects of the project;
provide, over the network to the performer of each proposal of the set of proposals, one or more of notification of the acceptance of the proposal for the subproject and at least a portion of an implementation schedule corresponding to the subproject;
for each subproject of the plurality of subprojects:
receive, over the network, completion data providing indication that the performer completed the subproject;
receive, over the network, an acceptance of the subproject from the project implementation user;
alert, over the network, a next performer that a next subproject is set to begin;
receive a clearpath approval from the next performer that the subproject is complete; and
initiate a payment based on the proposal of the performer.

9. The system of claim 8, wherein the one or more processors are further to receive an estimated required date and to generate project implementation data based on the proposals and the estimated required date.

10. The system of claim 8, wherein the memory and processors are further to receive an estimated a target total value of the project.

11. The system of claim 8, wherein the processors are further to:
determine if an inspection by an independent inspector is required;
transmit, over the network, an inspection request to the independent inspector; and
receive inspector acceptance of the subproject.

12. The system of claim 8, wherein the processors are further to determine the next subproject and a corresponding next performer, based on the implementation schedule.

13. The system of claim 8, wherein the memory and processors are further to:
determine, based on timing for performing the plurality of subprojects, one or more of an implementation schedule and an estimated required date; and
access performer data of the performer of each of the proposals to determine performer availability.

14. The system of claim 13, wherein the performer availability is determined relative to one or more of a timeframe of the project, the estimated required date, an implementation schedule, and a target total value of the project.

15. The system of claim 8, wherein the proposals are each provided by a performer that intends to complete the subproject and each include value data for completing the subproject and timing data that includes at least one of a duration for completing the subproject and a schedule of tasks for completing the corresponding subproject.

16. The system of claim 8, wherein the memory and processors are further to:
receive site data providing information about a site at which the project is to be accomplished; and
provide, over the network, site feedback information for the site.

17. The system of claim 16, wherein the site feedback information comprises one or more of:
compatibility information for the site,
purchase information for the site, and
ownership evidence for the site.

18. The system of claim 8, wherein the memory and processors are further to:
receive financing data providing information about financing for the project, the financing data including a financing budget for the project; and
determine compatibility of the financing budget and the project.

19. A system to coordinate proposals to accomplish a project, comprising:
a memory and one or more processors in electrical communication with the memory and to receive and transmit data via a network interface to communicate over a network, the one or more processors to execute instructions to cause the system to:
receive plan data for a plan for a project to be accomplished, the plan data including information for a plurality of subprojects of the project;
create a plan record in the memory, the plan record including the plan data;
receive, over the network, one or more proposals for each of the plurality of subprojects, each proposal provided by a performer that proposes to complete the corresponding subproject of the project, the proposal including value data for completing the subproject and timing data that includes at least one of a duration for completing the subproject and a schedule of tasks for completing the subproject;
create a proposal record in the memory for each of the one or more proposals, wherein the proposal record is associated with the plan record;
generate project implementation data based on a set of proposals to accomplish the project according to the plan, the set of proposals selected by a project implementation user, the project implementation data including a total value according to the value data of the set of proposals and an implementation schedule coordinating timing of implementation of the subprojects according to the timing data of the set of proposals; and
provide, over the network to the project implementation user, the project implementation data for presentation to the project implementation user.

20. The system of claim 19, the one or more processors further to:
for each subproject of the plurality of subprojects:
receive, over the network, an indication that the performer completed the subproject;
receive, over the network, an acceptance of the completion of the subproject;
communicate to a next performer, over the network, an indication that a next subproject is cleared to begin;
receive a clearpath approval from the next performer that the subproject is complete; and
initiate a payment for the subproject based on the proposal of the performer.
